(19) United States
(12) Patent Application Publication
(10) Pub. No.: US 2019/0191484 A1
(43) Pub. Date: Jun. 20, 2019

(54) COMMUNICATION SYSTEM, RECEPTION DEVICE, AND TRANSMISSION DEVICE

(71) Applicant: NEC CORPORATION, Tokyo (JP)

(72) Inventor: Shingo KIKUCHI, Tokyo (JP)

(73) Assignee: NEC CORPORATION, Tokyo (JP)

(21) Appl. No.: 16/219,152

(22) Filed: Dec. 13, 2018

(30) Foreign Application Priority Data
Dec. 19, 2017 (JP) 2017-242923

(51) Int. Cl. H04W 80/02; H04W 80/08; H04W 28/06; H04W 76/11

(52) U.S. Cl. CPC H04W 80/02; H04W 76/11; H04W 28/06; H04W 80/08

(57) ABSTRACT

In order to provide a communication system or the like which can improve processing latency that occurs in a reception device, the communication system includes a transmission device for performing transmission of a PDU including a Payload consisting of one or more data elements to a reception device and the reception device for performing reception of the PDU. The transmission device performs transmission of a first PDU which includes only the data element scheduled to be changed from a first format that conforms to a predetermined standard to a second format that does not conform to the standard by the reception device in an element storage area for storing the data element of the Payload and a second PDU which includes only the data element not being the first element in the element storage area.

This application is based upon and claims the benefit of priority from Japanese Patent Application No. 2017-242923, filed on Dec. 19, 2017, the disclosure of which is incorporated herein in its entirety by reference.

### TECHNICAL FIELD

The present invention relates to a communication system which sends information with a predefined format to a reception device from a transmission device.

### BACKGROUND ART

A User-plane protocol stack (hereinafter, referred to as a protocol stack) conforming to the 3GPP's LTE specification has a layered architecture which consists of PHY, MAC, and RLC layers and is constructed in a bottom-up manner (refer to Non-patent literature 1 shown below). Here, 3GPP is an abbreviation of Third Generation Partnership Project. Further, LTE is an abbreviation of Long Term Evolution. Further, PHY is an abbreviation of physical. Further, MAC is an abbreviation of Media Access Control. Furthermore, RLC is an abbreviation of Radio Link Control.

Further, a MAC-PDU structure is disclosed in Non-patent literature 2 shown below. Here, PDU is an abbreviation of Protocol Data unit.

For example, as an eNB for performing reception processing of a MAC-PDU, a configuration shown in FIG. 1 may be used. Here, eNB is an abbreviation of E-UTRAN NodeB. Further, UTRAN is an abbreviation of Universal Terrestrial Radio Access Network.

FIG. 1 is a conceptual diagram illustrating a configuration of an eNB 404 that is a common eNB for performing reception processing of the MAC-PDU.

The eNB 404 includes an antenna-RF unit 441, a PHY processing unit 442, a MAC processing unit 443, an RLC processing unit 444, and a PDCP processing unit 445. Here, PDCP is an abbreviation of Packet Data Convergence Protocol.

The antenna-RF unit 441 converts a wireless signal received in a wireless space into a signal for reception and sends it to the PHY processing unit 442. The signal for reception is, for example, a baseband signal.

The PHY processing unit 442 is a CPU (Central Processing Unit) or the like for performing the processing of the PHY layer of the protocol stack.

The PHY processing unit 442 performs demodulation and decoding of the signal for reception inputted from the antenna-RF unit 441. The PHY processing unit 442 obtains the MAC-PDU from the signal after demodulation and decoding and sends it to the MAC processing unit 443.

The MAC processing unit 443 is a CPU or the like for performing the processing of the MAC layer of the protocol stack.

The MAC-PDU sent to the MAC processing unit 443 from the PHY processing unit 442 includes a MAC-Header and a MAC-Payload.

The MAC processing unit 443 obtains an LCID in the MAC-Header included in the MAC-PDU sent from the PHY processing unit 442. Here, LCID is an abbreviation of Local Identifier.

The MAC processing unit 443 holds the LCID and data indicating a layer, that is either the MAC layer or the RLC layer, in which the content of the MAC-Payload has to be handled in advance. The data is disclosed on page 90 of Non-patent literature 2 shown below.

The MAC processing unit 443 determines the layer, that is either the MAC layer or the RLC layer, in which the content of the MAC-Payload has to be handled on the basis of the obtained LCID and the data.

Hereinafter, the MAC-Payload handled in the MAC layer is referred to as a MAC-Payload for MAC. The MAC-Payload for MAC does not have a format conforming to the standard for RLC.

Further, the MAC-Payload handled in the RLC layer is referred to as a MAC-Payload for RLC. The MAC-Payload for RLC has a format conforming to the standard for RLC.

The MAC-Payload for RLC is called a MAC SDU when it is viewed while focusing on the MAC. Here, SDU is an abbreviation of Service Data Unit. On the other hand, the MAC-Payload for RLC is called an RLC-PDU when it is viewed while focusing on the RLC. In the following description, the MAC-Payload for RLC, the MAC SDU, and the RLC-PDU are synonymous with each other.

When the MAC processing unit 443 determines that the obtained the MAC-Payload is the MAC-Payload for MAC, the MAC processing unit 443 processes the MAC-Payload. The details of the process are described in Non-patent literature 2 described below.

On the other hand, when the MAC processing unit 443 determines that the obtained MAC-Payload is the RLC-PDU, the MAC processing unit 443 sends the RLC-PDU to the RLC processing unit 444.

The RLC processing unit 444 is a CPU or the like for processing the RLC layer of the protocol stack.

The RLC processing unit 444 converts the RLC-PDU transferred from the MAC processing unit 443 that has a format conforming to the standard for RLC into a PDCP-PDU that does not conform to the standard for RLC. The RLC processing unit 444 sends the PDCP-PDU to the PDCP processing unit 445.

The PDCP processing unit 445 converts the PDCP-PDU sent from the RLC processing unit 444 into User-Data having a format to perform a subsequent process. The PDCP processing unit 445 sends the User-Data to a User-Data processing unit.

Further, an abbreviation of a term and an explanation of a term that are described in this section are also applied to the section of “Description of Embodiments”.

Non-Patent Literature 1

3GPP TS 36.300 V14.3.0 (2017-06), [searched on 29 Nov. 2017], Internet (http://www.etsi.org/deliver/etsi_ts/136300_136399/136300/14.03.00_60/ts_136300v140300p.pdf)

Non-Patent Literature 2

3GPP TS 36.321 V14.3.0 (2017-06), [searched on 29 Nov. 2017], Internet (http://www.etsi.org/deliver/etsi_ts/136300_136399/136321/14.03.00_60/ts_136321v140300p.pdf)

Non-Patent Literature 3

3GPP TR 38.802 V14.0.0 (2017-03) 5.5, [searched on 29 Nov. 2017], Internet (https://portal.3gpp.org/desktopmodules/Specifications/SpecificationDetails.aspx?specificationId=3066)

When the MAC-PDU does not include the MAC-Payload for MAC and includes only the RLC-PDU, the MAC processing unit 443 shown in FIG. 1 obtains the RLC-PDU from the MAC-PDU and performs only a process of transferring it to the RLC processing unit. In this case, if the number of transferring times of the RLC-PDU can be reduced, a throughput of a transfer process decreases and whereby, processing latency for user data in the eNB can be improved by the amount of reduction.

Here, in 5G NR (New Radio), a Carrier aggregation in which sixteen Carrier Components (CCs) are aggregated is being studied (refer to Non-patent literature 3 described above). In this case, it is assumed that the MAC-PDU is received for each CC and the MAC-PDU does not include the MAC-Payload for MAC and includes only the MAC-Payload for RLC in all the CCs. In the case, the MAC processing unit needs to perform the transfer process by the number of times calculated by multiplying sixteen (the number of the CCs) by the number of Users to be processed. Processing cycle consumption of the MAC processing unit and the processing latency for the User-Data increase by the transfer process by the above-mentioned calculated number of times. Accordingly, in 5G NR, the reduction of the number of transferring times is especially effective in improving the processing latency for the user data in the eNB.

### SUMMARY

An example object of the present invention is to provide a communication system or the like which can improve processing latency in a reception device.

The communication system of the present invention is a communication system which includes a transmission device for performing transmission of a PDU that is a Protocol Data Unit including a Payload consisting of one or more data elements to a reception device and the reception device for performing reception of the PDU, wherein the transmission device performs transmission of a first PDU that is the PDU which includes only a first element that is the data element scheduled to be changed from a first format that conforms to a predetermined standard to a second format that does not conform to the standard by the reception device in an element storage area for storing the data element of the Payload and a second PDU that is the PDU which includes only a second element that is the data element not being the first element in the element storage area and the reception device extracts the first PDU and the second PDU from the received PDU, sends the first PDU to a first processing unit for processing the first PDU, and sends the second PDU to a second processing unit for processing the second PDU so that the first and second PDUs are processed in the first and second processing units separately, respectively.

The communication system or the like of the present invention can improve processing latency in the reception device.

### BRIEF DESCRIPTION OF THE DRAWINGS

Exemplary features and advantages of the present invention will become apparent from the following detailed description when taken with the accompanying drawings in which:

FIG. 1 is a conceptual diagram illustrating an example of a configuration of a common eNB which performs reception processing of a MAC-PDU;

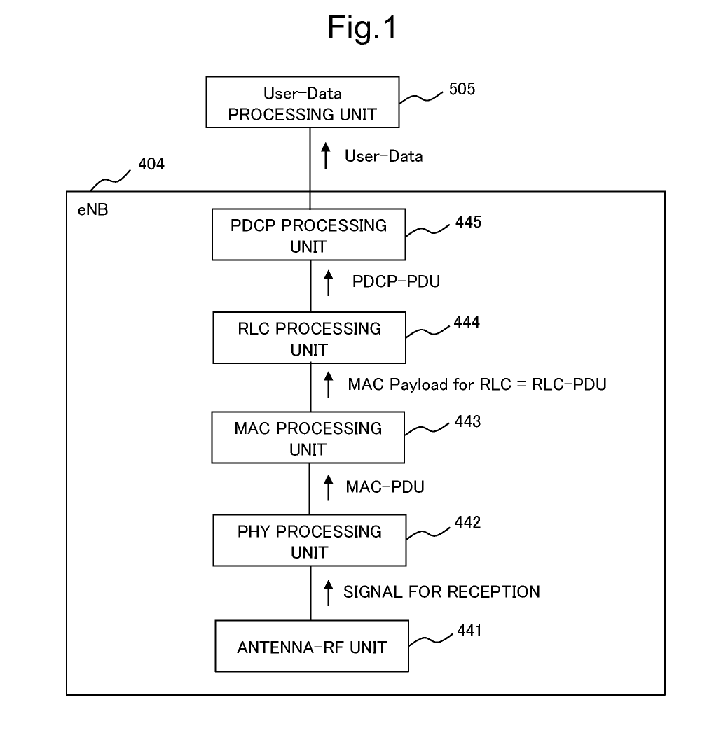

FIG. 2 is a conceptual diagram illustrating an example of a configuration of a communication system according to this example embodiment;

FIG. 3 illustrates an example of a structure of a MAC-PDU in which only Padding and Media Access Control Control Element are included in a MAC-Payload;

FIG. 4 is a table showing an example of a structure of each field included in a MAC-PDU;

FIG. 5 illustrates an example of a structure of a MAC-PDU in which only Padding and Common Control Channel are included in a MAC-Payload;

FIG. 6 illustrates an example of a structure of a MAC-PDU in which only Padding and RLC-PDU are included in a MAC-Payload; and

FIG. 7 is a conceptual diagram illustrating a minimum configuration of a communication system according to an example embodiment.

### EXAMPLE EMBODIMENT

Next, a detailed explanation will be given for a first example embodiment with reference to the drawings.

### Configuration and Operation

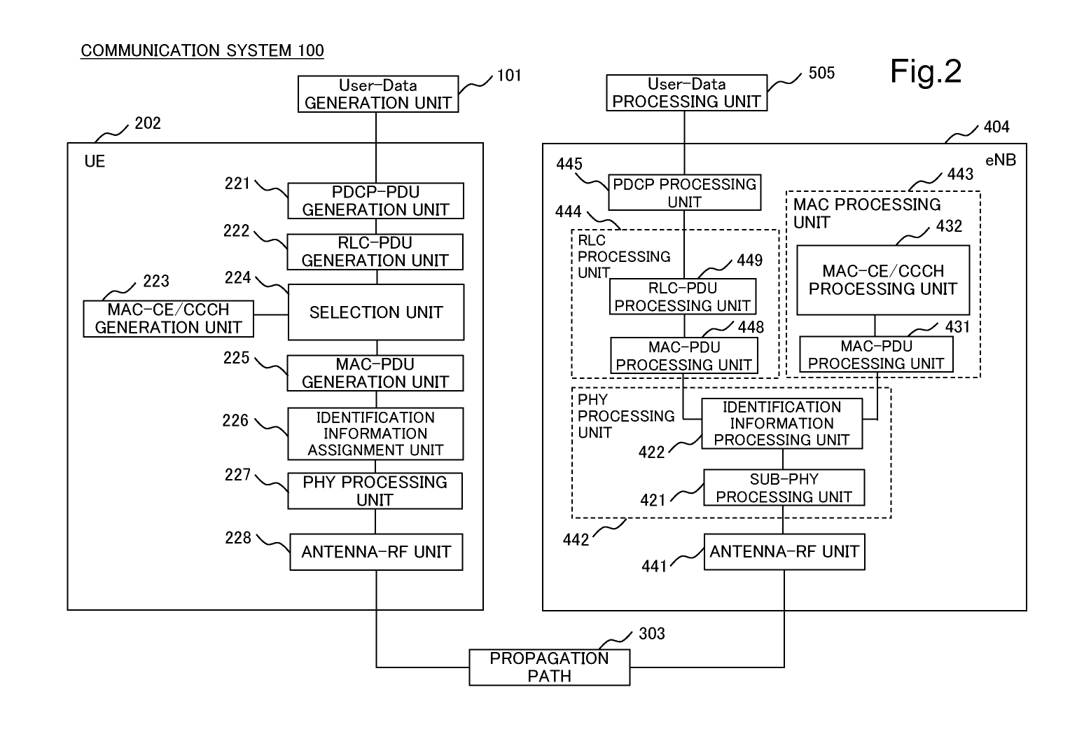

FIG. 2 is a conceptual diagram illustrating a configuration of a communication system 100 that is an example of a communication system according to this example embodiment.

The communication system 100 includes a User-Data generation unit 101, a UE 202, a propagation path 303, an eNB 404, and a User-Data processing unit 505.

The UE 202 includes a PDCP-PDU generation unit 221, an RLC-PDU generation unit 222, a MAC-CE/CCCH generation unit 223, a selection unit 224, a MAC-PDU generation unit 225, and an identification information assignment unit 226. Further, the UE 202 includes a PHY processing unit 227 and an antenna-RF unit 228. Here, “MAC-CE” is an abbreviation of Media Access Control Control Element. Further, “CCCH” is an abbreviation of Common Control Channel.

On the other hand, the eNB 404 includes the antenna-RF unit 441, the PHY processing unit 442, the MAC processing unit 443, the RLC processing unit 444, and the PDCP processing unit 445.

The PHY processing unit 442 includes a sub-PHY processing unit 421 and an identification information processing unit 422.

The MAC processing unit 443 includes a MAC-PDU processing unit 431 and a MAC-CE/CCCH processing unit 432.

The RLC processing unit 444 includes a MAC-PDU processing unit 448 and an RLC-PDU processing unit 449.

The User-Data generation unit 101 generates predetermined User-Data and sends it to the PDCP-PDU generation unit 221 of the UE 202.

The PDCP-PDU generation unit 221 converts the User-Data sent from the User-Data generation unit 101 into the PDCP-PDU having a format conforming to the standard of PDCP and sends it to the RLC-PDU generation unit 222.

The RLC-PDU generation unit 222 converts the PDCP-PDU sent from the PDCP-PDU generation unit 221 into the RLC-PDU conforming to the standard for RLC and sends it to the selection unit 224.

The MAC-CE/CCCH generation unit 223 generates the MAC-CE and the CCCH. Here, the MAC-CE and the CCCH are disclosed in Non-patent literature 2 mentioned above. The MAC-CE and the CCCH belong to the MAC-Payload for MAC described in the section of “Background art”. The MAC-CE/CCCH generation unit 223 sends the generated MAC-CE or CCCH to the selection unit 224.

The selection unit 224 holds the RLC-PDU sent from the RLC-PDU generation unit 222, and the MAC-CE and the CCCH that are sent from the MAC-CE/CCCH generation unit 223. Hereinafter, either of the RLC-PDU, the MAC-CE or the CCCH are defined as a Payload element.

The selection unit 224 selects a Payload element group (a plurality of Payload elements) to be subsequently sent to the MAC-PDU generation unit 225 from among the held Payload elements. When selecting the Payload element group, the selection unit 224 makes the selection so that the Payload element included in the selected Payload element group is either the RLC-PDU or one of the MAC-CE and the CCCH.

The selection unit 224 sends the selected Payload element group to the MAC-PDU generation unit 225.

The MAC-PDU generation unit 225 stores the Payload element group sent from the selection unit 224 in a Payload element group storage area of the MAC-Payload, generates the MAC-PDU to which the MAC-Header is added, and sends it to the identification information assignment unit 226. Here, the Payload element group storage area is an area in the MAC-Payload, excluding at least the area in which the Reserved and the Padding described in Non-patent literature 2 described above are stored. The Payload element is not stored in a Payload element group non-storage area that is an area other than the Payload element group storage area of the MAC-Payload.

When the MAC-PDU sent from the MAC-PDU generation unit 225 includes the RLC-PDU, the identification information assignment unit 226 stores first identification information in a predetermined storage position of the MAC-Header included in the MAC-PDU. A value of the first identification information is, for example, “1”.

The above-mentioned storage position is, for example, an R Header Field that is a head of a first MAC-Sub-Header included in the MAC-Header (refer to page 68 of Non-patent literature 2 mentioned above).

Further, when the MAC-PDU sent from the MAC-PDU generation unit 225 includes the MAC-CE or the CCCH, the identification information assignment unit 226 stores second identification information in the above-mentioned storage position. When the value of the first identification information is “1”, the value of the second identification information is “0”.

The identification information assignment unit 226 sends the MAC-PDU to which one of the first identification information and the second identification information is assigned to the PHY processing unit 227.

Hereinafter, one of the first identification information and the second identification information is referred to as the identification information.

The PHY processing unit 227 converts the MAC-PDU sent from the identification information assignment unit 226 into a signal for transmission and sends it to the antenna-RF unit 228.

The antenna-RF unit 228 converts the signal for transmission sent from the PHY processing unit 227 into wireless electrical wave and transmits it to the propagation path 303.

The propagation path 303 includes, for example, a base station, a relay station, and the like. The wireless electrical wave transmitted by the antenna-RF unit 228 reaches the antenna-RF unit 441 of the eNB 404 through the propagation path 303.

The antenna-RF unit 441 converts the recieved wireless electrical wave into the signal for reception and sends it to the sub-PHY processing unit 421 of the PHY processing unit 442.

The sub-PHY processing unit 421 obtains the MAC-PDU from the signal for reception sent from the antenna-RF unit 441 and sends it to the identification information processing unit 422.

The identification information processing unit 422 determines whether the identification information stored in the storage position of the MAC-Header included in the MAC-PDU sent from the sub-PHY processing unit 421 is the first identification information or the second identification information.

When the identification information is the first identification information, the identification information processing unit 422 sends the MAC-PDU sent from the sub-PHY processing unit 421 to the MAC-PDU processing unit 448 of the RLC processing unit 444.

On the other hand, when the identification information is the second identification information, the identification information processing unit 422 sends the MAC-PDU sent from the sub-PHY processing unit 421 to the MAC-PDU processing unit 431 of the MAC processing unit 443.

The MAC-PDU processing unit 431 sends the MAC-CE and the CCCH that are the MAC-Payload included in the MAC-PDU sent from the identification information processing unit 422 to the MAC-CE/CCCH processing unit 432.

The MAC-CE/CCCH processing unit 432 performs processing of the content indicated by the MAC-CE or the CCCH sent from the MAC-PDU processing unit 431. This processing is, for example, a predetermined control process performed on the basis of the MAC-CE or the CCCH that is a control signal. The details of the control process is described in Non-patent literature 2 described above.

The MAC-PDU processing unit 448 of the RLC processing unit 444 sends the RLC-PDU that is the MAC-Payload included in the MAC-PDU sent from the identification information processing unit 422 to the RLC-PDU processing unit 449.

The RLC-PDU processing unit 449 converts the RLC-PDU sent from the MAC-PDU processing unit 448 into the PDCP-PDU that does not conform to the standard of the RLC and conforms to the standard of the PDCP and sends it to the PDCP processing unit 445.

The PDCP processing unit 445 converts the PDCP-PDU sent from the RLC-PDU processing unit 449 into the User-Data that does not conform to the standard of the PDCP and has a format suitable for the process performed in the User-Data processing unit 505 and sends it to the User-Data processing unit 505.

Next, an example of the MAC-PDU that is sent to the PHY processing unit 227 by the identification information assignment unit 226 shown in FIG. 2 will be described.

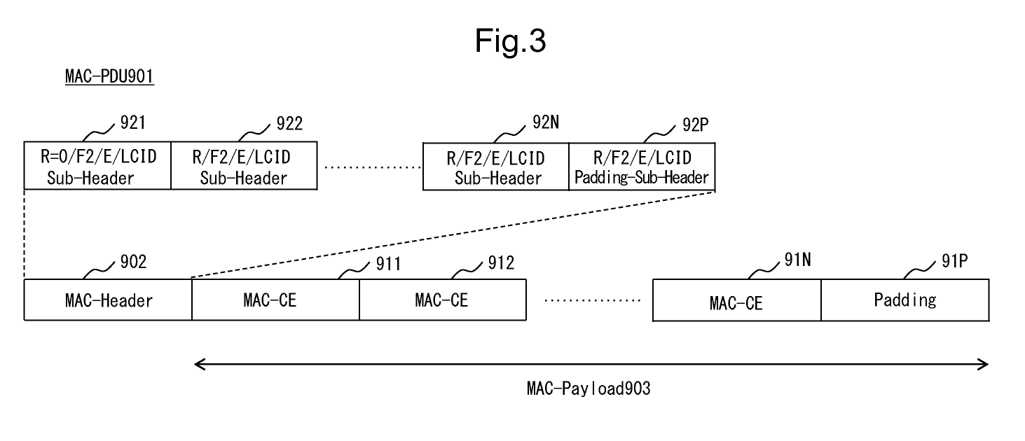

FIG. 3 illustrates a structure of a MAC-PDU 901 that is an example of the MAC-PDU which includes only the Padding and the MAC-CE in the MAC-Payload. Here, the Padding is described on page 69 of Non-patent literature 2 mentioned above.

The MAC-PDU 901 includes a MAC-Header 902 and a MAC-Payload 903.

The MAC-Payload 903 includes MAC-CEs 911 to 91N that are N Payload elements and a Padding 91P.

The MAC-Header 902 includes Sub-Headers 921 to 92N that are N Sub-Headers and a Padding-Sub-Header 92P.

The Sub-Headers 921 to 92N correspond to the MAC-CEs 911 to 91N, respectively. Specifically, each of the Sub-Headers 921 to 92N corresponds to each of the MAC-CEs 911 to 91N when the least significant digit of a reference number of the Sub-Headers 921 to 92N is equal to the least significant digit of a reference number of the MAC-CEs 911 to 91N.

Each Sub-Header consists of Header Fields R/F2/E/LCID (refer to page 68 of Non-patent literature 2 mentioned above).

A value (R value) of the R Header Field of the Sub-Header 921 is “0”. The R value of “0” indicates that the MAC-Payload of the MAC-PDU 901 does not include the RLC-PDU. “0” of the R value is a value of the second identification information that is stored by the identification information assignment unit 226 shown in FIG. 2.

Further, the Padding-Sub-Header 92P is the Sub-Header corresponding to the Padding 91P (refer to page 69 of Non-patent literature 2 mentioned above).

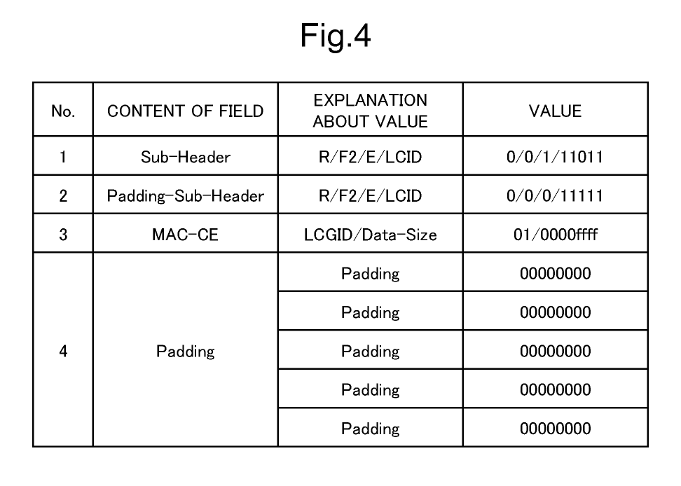

FIG. 4 is a table showing an example of the structure of each field included in the MAC-PDU 901 shown in FIG. 3.

Here, in the table of FIG. 4, the Sub-Header field, the Padding-Sub-Header field, the Payload element (MAC-CE) field, and the Padding field that are shown in FIG. 3 are listed. In FIG. 4, it is assumed that the MAC-Payload 903 shown in FIG. 3 includes only the MAC-CE 911 and the Padding 91P.

In row No. 1 of the table shown in FIG. 4, it is indicated that a first Sub-Header corresponding to the MAC-CE that is a first Payload element consists of a data string of 8 bits and the values of the Header Fields R/F2/E/LCID are 0/0/1/11011, respectively in this order. Here, the Header Fields R/F2/E/LCID are described on page 68 of Non-patent literature 2 mentioned above. Further, because the values of the Header Fields F2/E in row No. 1 are not directly relevant to the present invention, the explanation is omitted.

The R value of “0” indicates that the MAC-Payload of the MAC-PDU 901 does not include the RLC-PDU. “0” of the R value is a value of the second identification information that is stored by the identification information assignment unit 226 shown in FIG. 2.

Further, it is described that “11011” of the value of the Header Field of the LCID corresponds to the MAC-CE on page 90 of Non-patent literature 1 mentioned above.

In row No. 2 of the table shown in FIG. 4, it is indicated that the Padding-Sub-Header corresponding to the Padding consists of a data string of 8 bits and the values of the Header Fields R/F2/E/LCID are 0/0/0/11111, respectively in this order. “11111” of the value of the Header Field LCID indicates the Padding. This is described on page 90 of Non-patent literature 2 mentioned above. Further, because each of the values of the Header Fields R/F2/E in row No. 2 is not directly relevant to the present invention, the explanation is omitted.

In row No. 3 of the table shown in FIG. 4, it is indicated that the first Payload element is the MAC-CE, and LCGID/Data-Size of the MAC-CE are 01/0000ffff, respectively in this order. Here, “LCGID” is an abbreviation of Logical Channel Group Identifier. This is described on pages 72 and 73 of Non-patent literature 2 mentioned above.

In row No. 4 of the table shown in FIG. 4, it is indicated that a number of consecutive bits of “0” are appended as the Padding and the number of consecutive 0s is equal to a value calculated by multiplying 8 by 5.

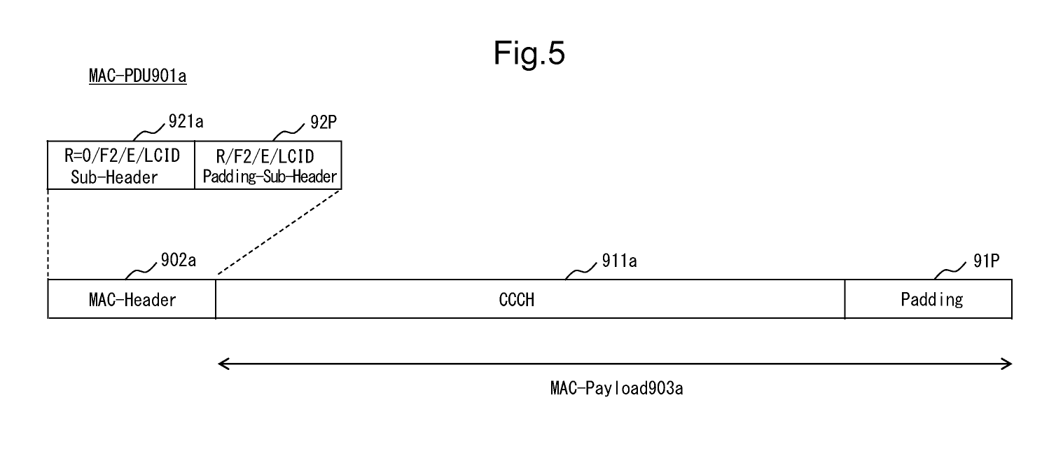

FIG. 5 illustrates a structure of a MAC-PDU 901a that is an example of the MAC-PDU which includes only the Padding and the CCCH in the MAC-Payload.

The MAC-PDU 901a includes a MAC-Header 902a and a MAC-Payload 903a.

The MAC-Payload 903a includes a CCCH 911a that is the Payload element and the Padding 91P.

The MAC-Header 902a includes a Sub-Header 921a and the Padding-Sub-Header 92P.

The Sub-Header 921a corresponds to the CCCH 911a.

The R value of the Sub-Header 921a is “0”. The R value of “0” indicates that the MAC-Payload of the MAC-PDU 901a does not include the RLC-PDU. “0” of the R value is a value of the second identification information that is stored by the identification information assignment unit 226 shown in FIG. 2.

Further, the Padding-Sub-Header 92P is the Sub-Header corresponding to the Padding 91P.

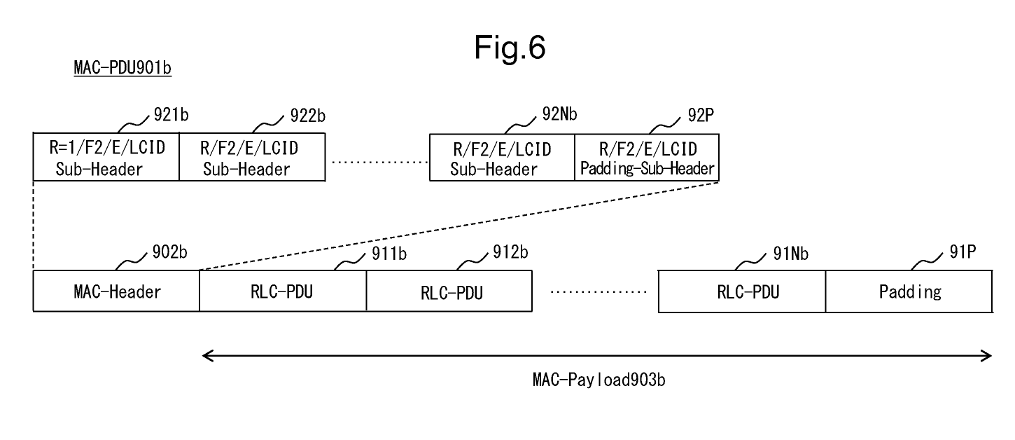

FIG. 6 illustrates a structure of a MAC-PDU 901b that is an example of the MAC-PDU which includes only the RLC-PDU in the MAC-Payload excluding the Padding.

The MAC-PDU 901b includes a MAC-Header 902b and a MAC-Payload 903b.

The MAC-Payload 903b includes RLC-PDUs 911b to 91Nb that are N Payload elements and the Padding 91P.

The MAC-Header 902b includes Sub-Headers 921b to 92Nb that are N Sub-Headers and the Padding-Sub-Header 92P.

The Sub-Headers 921b to 92Nb correspond to the RLC-PDUs 911b to 91Nb, respectively. Specifically, each of the Sub-Headers 921b to 92Nb corresponds to each of the RLC-PDUs 911b to 91Nb when the value of the third digit (counting from left to right) of the reference number of the Sub-Header is equal to the value of the third digit (counting from left to right) of the reference number of the RLC-PDU.

The R value of the Sub-Header 921b is “1”. The R value of “1” indicates that the MAC-Payload of the MAC-PDU 901b includes only the RLC-PDU along with the Padding and a Reserved (not shown), in other words, the MAC-Payload does not include the MAC-CE and the CCCH. “1” of the R value is the value of the first identification information that is stored by the identification information assignment unit 226 shown in FIG. 2.

The Padding-Sub-Header 92P is the Sub-Header corresponding to the Padding 91P.

Further, in the above-mentioned description, a case of an Up-Link in which the User-Data is sent to the eNB from the UE has been explained as an example. However, in a case in which data is sent to the UE from the eNB, a similar configuration can be used.

In this case, the terms used in the above-mentioned description for explaining the operation of the communication system 100 should be changed as follows.

The words “User-Data”, “UE”, “User-Data generation unit”, “eNB”, and “User-Data processing unit” should be changed to “Data”, “eNB”, “Data generation unit”, “UE”, and “Data processing unit”, respectively in this order.

### Effect

The transmission device of the communication system according to this example embodiment uses either the Payload element only for MAC or the Payload element only for RLC as the Payload element stored in the MAC-Payload of the MAC-PDU for transmissions. Further, the transmission device stores identification information indicating whether the Payload element is only for MAC or for RLC in the predetermined storage position of the MAC-Header of the MAC-PDU for transmissions.

The reception device of the communication system determines whether the Payload element stored in the MAC-Payload of the received MAC-PDU is only for MAC or for RLC by the identification information. The reception device sends the received MAC-PDU to either the MAC processing unit for performing a process related to the MAC or the RLC processing unit for performing a process related to the RLC on the basis of a determination result so that a process related to the MAC is performed by the MAC processing unit and a process related to the RLC is performed by the RLC processing unit separately.

Therefore, in the communication system, the transfer process in which the MAC processing unit of the reception device transfers the RLC-PDU to the RLC-PDU processing unit is not performed unlike the method described in the section of “Background art”.

Therefore, the communication system can improve the processing latency in the reception device that occurs in the transfer process in which the MAC processing unit transfers the RLC-PDU to the RLC-PDU processing unit.

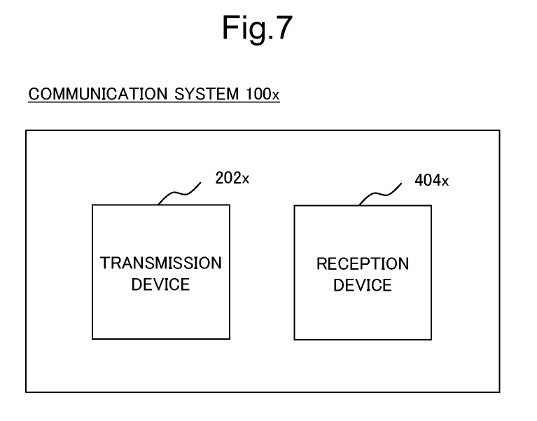

FIG. 7 is a conceptual diagram illustrating a configuration of a communication system 100x that is a minimum configuration of the communication system according to this example embodiment.

The communication system 100x includes a transmission device 202x and a reception device 404x.

The transmission device 202x performs transmission of the MAC-PDU including the MAC-Payload consisting of one or more data elements to the reception device. Here, “MAC-Payload” is an abbreviation of Media Access Control Payload. “MAC-PDU” is an abbreviation of Media Access Control Protocol Data Unit.

Further, the reception device 404x performs reception of the MAC-PDU.

The transmission device 202x performs transmission of a first MAC-PDU and a second MAC-PDU. Here, the first MAC-PDU is the MAC-PDU including only a first element in an element storage area for storing the data element of the MAC-Payload. The first element is the data element scheduled to be changed from the first format that conforms to the standard related to the RLC that is the Radio Link Control to the second format that does not conform to the standard by the reception device. Further, the second MAC-PDU is the MAC-PDU including only the second element that is the data element not being the first element in the element storage area.

The reception device 404x extracts the first MAC-PDU and the second MAC-PDU from the received MAC-PDU, sends the first MAC-PDU to a first processing unit, and sends the second MAC-PDU to a second processing unit so that the first and second MAC-PDUs are processed in the first and second processing units, respectively.

Therefore, in the communication system, the transfer process in which one processing unit of the reception device 404x receives the MAC-PDU and transfers the first MAC-PDU to another processing unit for performing a process related to the RLC is not performed unlike the method described in the section of “Background art”.

Therefore, the communication system 100x can improve the processing latency in the reception device 404x that occurs in the transfer process.

Therefore, because the communication system 100x has the above-mentioned configuration, the communication system 100x has an effect described in the section of “Advantageous Effects of Invention”.

Further, the communication system 100x shown in FIG. 7 may be, for example, the communication system 100 shown in FIG. 2. Further, the transmission device 202x may be, for example, the UE 202 shown in FIG. 2. Further, the reception device 404x may be, for example, the eNB 404 shown in FIG. 2. Further, the first MAC-PDU may be, for example, the MAC-PDU for RLC. Further, the second MAC-PDU may be, for example, the MAC-PDU for MAC. Further, the first processing unit may be, for example, the RLC processing unit 444 shown in FIG. 2. Furthermore, the second processing unit may be, for example, the MAC processing unit 443 shown in FIG. 2.

Each example embodiment of the present application has been described above. However, the present invention is not limited to the example embodiment described above. Various changes, replacement, or adjustment can be applied to the configuration of each exemplary embodiment described above without departing from the basic technical idea of the present invention. For example, the configuration of the element shown in each drawing is shown as an example to give a better understanding of the present invention. Therefore, the configuration of the element is not limited to the configuration shown in these drawings.

The whole or part of the example embodiments disclosed above can be described as, but not limited to, the following supplementary notes.

### Supplementary Note 1

A communication system including a transmission device for performing transmission of a PDU that is a Protocol Data Unit including a Payload including one or more data elements to a reception device and the reception device for performing reception of the PDU, wherein the transmission device performs the transmission of a first PDU that is the PDU which includes only a first element that is the data element scheduled to be changed from a first format that conforms to a predetermined standard to a second format that does not conform to the standard by the reception device in an element storage area for storing the data element of the Payload and a second PDU that is the PDU which includes only a second element that is the data element not being the first element in the element storage area, and the reception device extracts the first PDU and the second PDU from the received PDU, sends the first PDU to a first processing unit for processing the first PDU, and sends the second PDU to a second processing unit for processing the second PDU so that the first and second PDUs are processed in the first and second processing units separately, respectively.

### Supplementary Note 2

The communication system according to Supplementary note 1, in which the Payload is a Media Access Control Payload, the PDU is a Media Access Control PDU, and the standard is a standard related to an RLC that is a Radio Link Control.

### Supplementary Note 3

The communication system described in Supplementary note 2 in which the first element includes an RLC-PDU.

### Supplementary Note 4

The communication system described in Supplementary note 2 or Supplementary note 3 in which the second element includes a Media Access Control Control Element or a Common Control Channel.

### Supplementary Note 5

The communication system described in any one of Supplementary notes 1 to 4 in which the data element is not stored in an element non-storage area that is an area not being the element storage area of the Payload.

### Supplementary Note 6

The communication system described in Supplementary note 5 in which a Reserved and a Padding are stored in the element non-storage area.

### Supplementary Note 7

The communication system described in any one of Supplementary notes 1 to 5 in which the transmission device assigns identification information indicating whether the PDU is the first PDU or the second PDU to the PDU to be transmitted.

### Supplementary Note 8

The communication system described in Supplementary note 7 in which the transmission device stores the identification information in a Header included in the PDU.

### Supplementary Note 9

The communication system described in Supplementary note 8 in which a storage position according to the storage is an R Header Field included in a Sub-Header that is a head of the Header.

### Supplementary note 10

The communication system described in any one of Supplementary notes 7 to 9 in which the reception device extracts the first PDU and the second PDU from the received PDU on the basis of identification information.

### Supplementary Note 11

The communication system described in any one of Supplementary notes 1 to 10 in which the first processing unit and the second processing unit are the devices separated from each other.

### Supplementary Note 12

The communication system described in Supplementary note 11 in which the device is a central processing device.

### Supplementary Note 13

A reception device which receives a first PDU that is a PDU being a Protocol Data Unit including a Payload including one or more data elements which includes only a first element that is the data element scheduled to be changed from a first format that conforms to a predetermined standard to a second format that does not conform to the standard in an element storage area for storing the data element of the Payload and a second PDU that is the PDU which includes only a second element that is the data element not being the first element in the element storage area that are transmitted from a transmission device, extracts the first PDU and the second PDU from the received PDU, sends the first PDU to a first processing unit for processing the first PDU, and sends the second PDU to a second processing unit for processing the second PDU so that the first and second PDUs are processed in the first and second processing units separately, respectively.

### Supplementary Note 14

A transmission device which extracts a first PDU which includes only a first element that is a data element scheduled to be changed from a first format that conforms to a predetermined standard to a second format that does not conform to the standard in an element storage area for storing the data element of a Payload and a second PDU which includes only a second element that is the data element not being the first element in the element storage area from the received PDU that is a Protocol Data Unit including the Payload including one or more data elements, sends the first PDU to a first processing unit for processing the first PDU, and sends the second PDU to a second processing unit for processing the second PDU so that the first and second PDUs are processed in the first and second processing units separately, respectively.

### Supplementary Note 15

A communication method for performing transmission of a PDU that is a Protocol Data Unit including a Payload including one or more data elements and performing reception of the PDU, wherein

the transmission is transmission of a first PDU that is the PDU which includes only a first element that is the data element scheduled to be changed from a first format that conforms to a predetermined standard to a second format that does not conform to the standard by the reception in an element storage area for storing the data element of the Payload and a second PDU that is the PDU which includes only a second element that is the data element not being the first element in the element storage area and

at the time of the reception, the first PDU and the second PDU are extracted from the received PDU, the first PDU is sent to one processing unit for processing the first PDU, and the second PDU is sent to another processing unit for processing the second PDU so that the first and second PDUs are processed in two different processing units separately, respectively.

### REFERENCE SIGNS LIST

100 and 100x communication system

101 User-Data generation unit

202 UE

202x transmission device

221 PDCP-PDU generation unit

222 RLC-PDU generation unit

223 MAC-CE/CCCH generation unit

224 selection unit

225 MAC-PDU generation unit

226 identification information assignment unit

227 PHY processing unit

228 and 441 antenna-RF unit

303 propagation path

404 eNB

404x reception device

442 PHY processing unit

421 sub-PHY processing unit

422 identification information processing unit

443 MAC processing unit

431 MAC-PDU processing unit

432 MAC-CE/CCCH processing unit

444 RLC processing unit

445 PDCP processing unit

448 MAC-PDU processing unit

449 RLC-PDU processing unit

505 User-Data processing unit

901, 901a, and 901b MAC-PDU

902, 902a, and 902b MAC-Header

903, 903a, and 903b MAC-Payload

911, 911a, 912, and 91N MAC-CE

911b, 912b, and 91Nb RLC-PDU

91P Padding

921, 921a, 921b, 922, 922a, 922b, 92N, 92Na, and 92Nb Sub-Header

92P Padding-Sub-Header

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

What is claimed is:

1. A communication system including a transmission device for performing transmission of a PDU that is a Protocol Data Unit including a Payload including one or more data elements to a reception device and the reception device for performing reception of the PDU, wherein
the transmission device performs the transmission of a first PDU that is the PDU which includes only a first element that is the data element scheduled to be changed from a first format that conforms to a predetermined standard to a second format that does not conform to the standard by the reception device in an element storage area for storing the data element of the Payload and a second PDU that is the PDU which includes only a second element that is the data element not being the first element in the element storage area, and
the reception device extracts the first PDU and the second PDU from the received PDU, sends the first PDU to a first processing unit for processing the first PDU, and sends the second PDU to a second processing unit for processing the second PDU so that the first and second PDUs are processed in the first and second processing units separately, respectively.

2. The communication system described in claim 1 in which the Payload is a Media Access Control Payload, the PDU is a Media Access Control PDU, and the standard is a standard related to an RLC that is a Radio Link Control.

3. The communication system described in claim 2 in which the first element includes an RLC-PDU.

4. The communication system described in claim 2 in which the second element includes a Media Access Control Control Element or a Common Control Channel

5. The communication system described in claim 1 in which the data element is not stored in an element non-storage area that is an area not being the element storage area of the Payload.

6. The communication system described in claim 5 in which a Reserved and a Padding are stored in the element non-storage area.

7. The communication system described in claim 1 in which the transmission device assigns identification information indicating whether the PDU is the first PDU or the second PDU to the PDU to be transmitted.

8. The communication system described in claim 7 in which the transmission device stores the identification information in a Header included in the PDU.

9. The communication system described in claim 8 in which a storage position according to the storage is an R Header Field included in a Sub-Header that is a head of the Header.

10. The communication system described in claim 7 in which the reception device extracts the first PDU and the second PDU from the received PDU on the basis of identification information.

11. The communication system described in claim 1 in which the first processing unit and the second processing unit are the devices separated from each other.

12. The communication system described in claim 11 in which the device is a central processing device.

13. A reception device which receives a first PDU that is a PDU being a Protocol Data Unit including a Payload including one or more data elements which includes only a first element that is the data element scheduled to be changed from a first format that conforms to a predetermined standard to a second format that does not conform to the standard in an element storage area for storing the data element of the Payload and a second PDU that is the PDU which includes only a second element that is the data element not being the first element in the element storage area that are transmitted from a transmission device, extracts the first PDU and the second PDU from the received PDU, sends the first PDU to a first processing unit for processing the first PDU, and sends the second PDU to a second processing unit for processing the second PDU so that the first and second PDUs are processed in the first and second processing units separately, respectively.

14. A communication method for performing transmission of a PDU that is a Protocol Data Unit including a Payload consisting of one or more data elements and performing reception of the PDU, wherein
the transmission is transmission of a first PDU that is the PDU which includes only a first element that is the data element scheduled to be changed from a first format that conforms to a predetermined standard to a second format that does not conform to the standard by the reception in an element storage area for storing the data element of the Payload and a second PDU that is the PDU which includes only a second element that is the data element not being the first element in the element storage area and
at the time of the reception, the first PDU and the second PDU are extracted from the received PDU, the first PDU is sent to one processing unit for processing the first PDU, and the second PDU is sent to another processing unit for processing the second PDU so that the first and second PDUs are processed in two different processing units separately, respectively.
